(19) United States
(12) Patent Application Publication
(10) Pub. No.: US 2015/0125719 A1
(43) Pub. Date: May 7, 2015

(54) POWER STORAGE DEVICE AND METHOD FOR RADIATING HEAT IN POWER STORAGE DEVICE

(71) Applicant: NEC CORPORATION, Tokyo (JP)

(72) Inventor: Hiroo Hongo, Tokyo (JP)

(73) Assignee: NEC Corporation, Tokyo (JP)

(21) Appl. No.: 14/388,362

(22) PCT Filed: Mar. 14, 2013
(86) PCT No.: PCT/JP2013/001716

§ 371 Date: Sep. 26, 2014

(30) Foreign Application Priority Data
Mar. 30, 2012 (JP) 2012-079417

(51) Int. Cl. H01M 10/637; H01M 10/6551

(52) U.S. Cl. CPC H01M 10/5026; H01M 10/5046; H01M 2200/10
USPC 429/50; 429/62

(57) ABSTRACT

[Problem] The object is to provide a power storage device and a method for radiating heat in a power storage body that can suppress temperature change in the power storage body even when the power storage body expands.

[Solution] A power storage device characterized by including: a power storage body; a heat transfer body thermally contacted with the power storage body; a heat radiating body thermally separated from both the power storage body and the heat transfer body; a heat-sensitive deformable body arranged so as to contact with the heat radiating body at a predetermined temperature due to positive thermal expansion and to separate from the heat radiating body at a temperature less than the predetermined temperature, and thermally contacted with the heat transfer body; and a heat insulating body thermally insulating the power storage body, the heat transfer body, and the heat-sensitive deformable body from surroundings.

### TECHNICAL FIELD

The present invention relates to a power storage device and a method for radiating heat in a power storage device.

### BACKGROUND ART

In recent years, power storage bodies such as a lithium ion secondary battery have been used for a variety of purposes including power supplies for electronic devices and electric automobiles, and electric power storage.

The lithium ion secondary battery, which is one type of power storage bodies, is known to generate heat during charging or discharging. Heat generation of a lithium ion secondary battery deteriorates a power storage element composed of a positive electrode, a negative electrode, separators, and the like, consequently degrading battery performance and shortening battery life. Other power storage bodies also have a predetermined operating temperature range, and when a temperature of a power storage body exceeds an upper limit value of the operating temperature range, power storage performance is deteriorated. Accordingly, appropriate heat radiation in a power storage body is desired.

On the other hand, reduction in battery temperature may be problematic. For example, when a power storage body is installed outdoors for the purpose of electric power storage, there is a case that an outside temperature becomes below the freezing point in winter or in a cold district. In the case of the lithium ion secondary battery, temperature reduction causes irreversible precipitation of lithium and thus capacity reduction may occur. Even the other power storage bodies have an operating temperature range. Thus, when a power storage body has a temperature below a lower limit value of the operating temperature range, power storage performance is deteriorated. It is therefore desirable to prevent excessive heat deprivation in a power storage body.

In other words, it is desirable to configure a power storage device that allows heat radiation when a power storage body is at high temperature and allows heat insulation when the power storage body is at low temperature.

Patent Literature 1 describes an example of a battery pack provided with a heat radiation mechanism. FIG. 11 includes sectional views of the battery pack described in Patent Literature 1. A battery pack 100 described in Patent Literature 1 includes a secondary battery 110, a pack outer package case 151 and a pack outer package cover 152 housing the secondary battery 110, and a metal heat radiating body 140 arranged in the pack outer package case 151. The battery pack 100 also includes a heat-sensitive deformable body 130 that faces the metal heat radiating body 140, is fixedly arranged on a side surface of the secondary battery 110, and contacts with the metal heat radiating body 140 due to thermal deformation upon temperature rise when the temperature exceeds a predetermined temperature.

The heat-sensitive deformable body 130 is, for example, a metal piece in the form of a thin plate, as depicted in FIG. 11(a), which has configuration in which the center of the metal piece is fixed to a side surface of the secondary battery 110 and both ends thereof are bent to spring up in a direction where the pack outer package case 151 is positioned. Upon rise of battery temperature, the heat-sensitive deformable body 130 contacts with the metal heat radiating body 140 due to thermal deformation, as depicted in FIG. 11(b), and heat generated in the secondary battery 110 is quickly radiated outside from the metal heat radiating body 140 through the heat-sensitive deformable body 130.

### PRIOR ART LITERATURE

### Patent Literature

Patent Literature 1: Japanese published unexamined application 2002-124224.

### SUMMARY OF INVENTION

### Technical Problem

However, Patent Literature 1 described above has the following problem. A volume of the power storage body may expand during repetitive charging and discharging. For example, a lithium ion secondary battery using material alloyed with lithium for a negative electrode mainly causes expansion and contraction of the negative electrode during charging and discharging.

As depicted in FIG. 11(c), when the secondary battery 110 in the battery pack described in Patent Literature 1 expands in a thickness direction thereof, the heat-sensitive deformable body 140 is pushed up together with the secondary battery 110 in the thickness direction because of being fixedly arranged on a side surface of the secondary battery 110. As a result, the heat-sensitive deformable body 130 is pushed against the metal heat radiating body 140 arranged on the pack outer package case 151 due to expansion of the secondary battery 110. When the heat-sensitive deformable body 130 is pushed against the metal heat radiating body 140, the heat-sensitive deformable body 130 is in contact with the metal heat radiating body 140 at all times, thus it is impossible to provide heat insulation between the metal heat radiating body 140 and the secondary battery 110.

The object of the present invention is to provide a power storage device and a method for radiating heat in a power storage device that solve the above problem.

### Solution to Problem

A power storage device according to the present invention is characterized by including a power storage body; a heat transfer body in thermal contact with the power storage body; a heat radiating body thermally separated from both the power storage body and the heat transfer body; a heat-sensitive deformable body arranged so as to contact with the heat radiating body at a predetermined temperature due to positive thermal expansion and to separate from the heat radiating body at a temperature less than the predetermined temperature, and in thermal contact with the heat transfer body; and a heat insulating body thermally insulating the power storage body, the heat transfer body, and the heat-sensitive deformable body from the surroundings.

In addition, a method for radiating heat in a power storage device according to the present invention is characterized by including a power storage body, a heat transfer body in thermal contact with the power storage body, a heat radiating body thermally separated from both the power storage body and the heat transfer body, a heat-sensitive deformable body in thermal contact with the heat transfer body, and a heat insulating body thermally insulating the power storage body, the heat transfer body, and the heat-sensitive deformable body from the surroundings; contacting the heat-sensitive deformable body with the heat radiating body at a predetermined temperature due to positive thermal expansion; and separating the heat-sensitive deformable body from the heat radiating body at a temperature less than the predetermined temperature.

### Advantageous Effects of Invention

According to the present invention, there can be provided a battery device and a method for radiating heat in a power storage device that solve the above problem.

### BRIEF DESCRIPTION OF DRAWINGS

FIG. 1 includes perspective views and a sectional view of a power storage device according to a first embodiment;

FIG. 2 includes sectional views depicting deformation of a heat-sensitive deformable body in the power storage device according to the first embodiment;

FIG. 3 includes sectional views depicting expansion of a power storage body in the power storage device according to the first embodiment;

FIG. 4 includes a perspective view and a sectional view of an example of the power storage device according to the first embodiment using, as the power storage body, a cylindrical power storage body in which a winding type power storage element is sealed;

FIG. 5 is a sectional view of the power storage device according to the first embodiment including a fixed portion;

FIG. 6 is a perspective view of an example using air bubble containing film as the heat-sensitive deformable body in the power storage device according to the first embodiment;

FIG. 7 includes sectional views of an example using the air bubble containing film as the heat-sensitive deformable body in the power storage device according to the first embodiment;

FIG. 8 is a view depicting a position for arranging the heat-sensitive deformable body in the power storage device according to the first embodiment;

FIG. 9 includes perspective views and a sectional view of an example in which a heat radiating body is a part of a housing in the power storage device according to the first embodiment;

FIG. 10 includes a perspective view and a sectional view of a power storage device according to a second embodiment; and

FIG. 11 includes sectional views of a battery pack described in Patent Literature 1.

### DESCRIPTION OF EMBODIMENTS

### First Embodiment

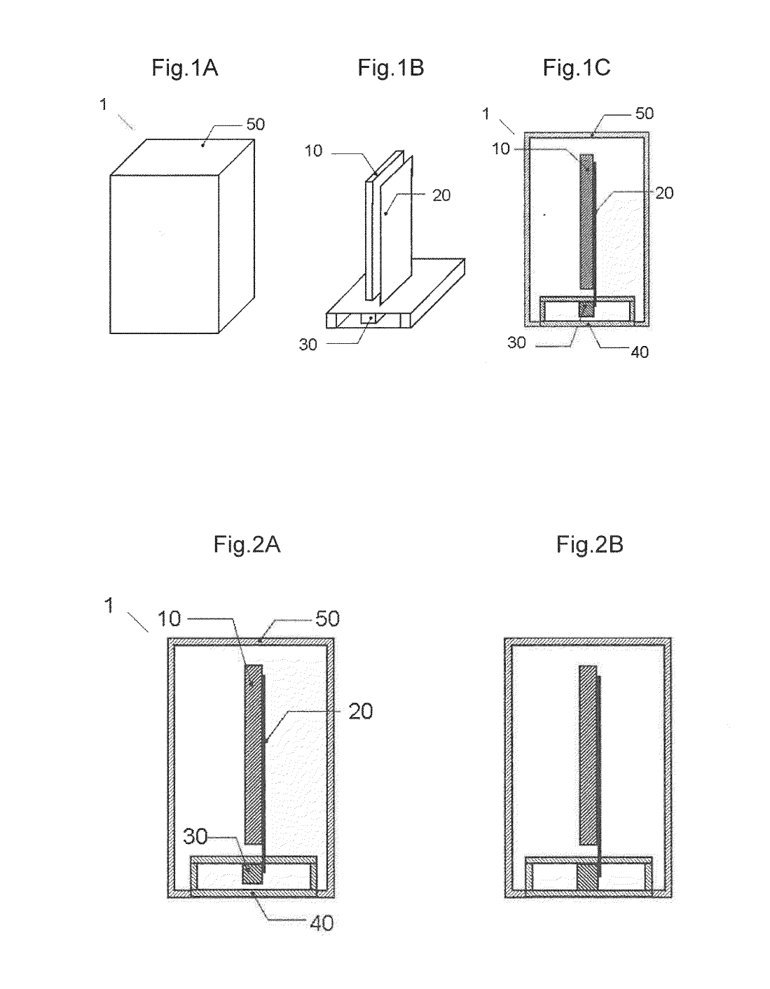

Hereinafter, a description will be given of forms of a power storage device according to a first embodiment of the present invention with reference to FIGS. 1 to 9.

As depicted in FIG. 1(a), in a power storage device 1 according to the first embodiment of the present invention, a housing 50 covers a power storage body 10, a heat transfer body 20, and a heat-sensitive deformable body 30. Inside the housing 50 are arranged the power storage body 10, the heat transfer body 20, and the heat-sensitive deformable body 30 depicted in FIG. 1(b). In the present embodiment, a heat radiating body 40 is provided on the housing 50. FIG. 1(c) is a sectional view of FIG. 1(a).

As depicted in FIG. 1(c), the power storage body 10 is in contact with the heat transfer body 20, and the heat transfer body 20 is in contact with the heat-sensitive deformable body 30. The heat-sensitive deformable body 30 is fixed so as to be separated from the heat radiating body 40 by a predetermined distance. The power storage body 10, the heat transfer body 20, and the heat-sensitive deformable body 30 are covered with the housing 50. The heat transfer body 20 transfers heat of the power storage body 10 to the heat-sensitive deformable body 30, and the heat-sensitive deformable body 30 deforms as temperature thereof rises. When a temperature of the heat-sensitive deformable body 30 reaches a predetermined level, the heat-sensitive deformable body 30 deformed is brought into contact with the heat radiating body 40 to transfer heat of the heat transfer body 20 to the heat radiating body 40.

FIG. 2 includes sectional views depicting deformation of the heat-sensitive deformable body 30 in the power storage device 1 according to the first embodiment of the present invention. As depicted in FIG. 2(a), heat of the power storage body 10 is transferred to the heat-sensitive deformable body 30 through the heat transfer body 20. When the power storage body 10 generates heat due to charging or discharging, heat of the heat-sensitive deformable body 30 rises and the heat-sensitive deformable body 30 deforms. FIG. 2(b) depicts an example of deformation of the heat-sensitive deformable body 30. When the heat-sensitive deformable body 30 expands along with a rise in temperature of the power storage body 10 and the temperature thereof reaches a predetermined level, the heat-sensitive deformable body 30 contacts with the heat radiating body 40. The heat radiating body 40 is in contact with outside air or the like. When a temperature of the outside air or the like is less than the temperature of the power storage body 10, the outside air or the like deprives heat of the power storage body 10 through the heat-sensitive deformable body 30, so that the temperature of the power storage body 10 does not exceed the predetermined temperature.

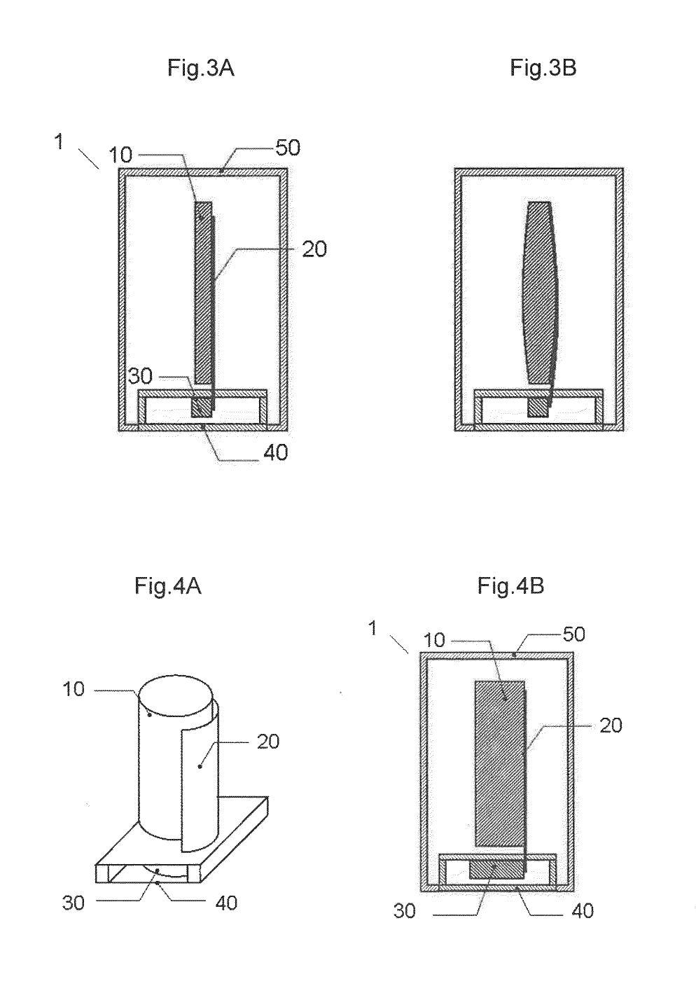

Meanwhile, a volume of the power storage body 10 may expand during repetitive charging and discharging. FIG. 3 includes sectional views depicting a state of expansion of the power storage body 10 in the first embodiment of the present invention. As depicted in FIG. 3(a), the heat-sensitive deformable body 30 is fixed so as to be separated from the heat radiating body 40 by a predetermined distance. Accordingly, as depicted in FIG. 3(b), even when the power storage body 10 expands, a distance between the heat-sensitive deformable body 30 and the heat radiating body 40 does not change. In the power storage device 1 according to the first embodiment of the present invention, even when the power storage body 10 expands, the heat-sensitive deformable body 30 can deform in accordance with the temperature of the power storage body 10 and can contact with the heat radiating body 40 at a predetermined temperature.

For example, even when a temperature of the heat radiating body 40 exceeds an upper limit value of an operating temperature range of the power storage body 10 due to influence of the outside air or the like, the heat-sensitive deformable body 30 does not contact with the heat radiating body 40 as long as the temperature of the power storage body 10 is less than the upper limit value of the operating temperature range. This is the same even when the power storage body 10 is in an expanded state. In addition, the power storage body 10, the heat transfer body 20, and the heat-sensitive deformable body 30 are thermally insulated from the outside air or the like by the housing 50, which thus plays a role as a heat insulating body. Accordingly, heat of the heat radiating body 40 is not transferred to the power storage body 10, and heat of the outside air or the like is not transferred to the power storage body 10, the heat transfer body 20, and the heat-sensitive deformable body 30, thus temperature rise in the storage battery 10 can be prevented.

In addition, even when a temperature of the heat radiating body 40 is less than a lower limit value of the operating temperature range of the power storage body 10 due to influence of the outside air or the like, the heat-sensitive deformable body 30 does not contact with the heat radiating body 40 as long as the temperature of the power storage body 10 is less than the upper limit value of the operating temperature range. This is the same even when the power storage body 10 is in an expanded state. Additionally, the power storage body 10, the heat transfer body 20, and the heat-sensitive deformable body 30 are thermally insulated from the outside air or the like by the housing 50. Accordingly, heat of the power storage body 10 is not deprived through the heat-sensitive deformable body 30, and heat of the power storage body 10, the heat transfer body 20, and the heat-sensitive deformable body 30 is not deprived by the outside air or the like, thus temperature reduction in the power storage body 10 can be prevented.

As the power storage body 10, various power storage bodies including secondary batteries such as a lithium ion secondary battery and capacitors such as an electric double layer capacitor may be used. For example, in a case of using a lithium ion secondary battery, the power storage body 10 having a flat shape as depicted in FIGS. 1 to 3 may be used, although not limited thereto. The power storage body 10 having a flat shape may be a power storage body in which a power storage element formed by alternately laminating a positive electrode and a negative electrode through a separator is sealed with a can made of iron or aluminum or with laminate.

A cylindrical power storage body may alternatively be used in which laminate of a positive electrode, a separator, and a negative electrode is wound into a swirl shape and a winding type power storage element is sealed. FIG. 4 depicts an example in which a cylindrical power storage body 10 is used in the first embodiment. FIG. 4(a) is a perspective view of an internal structure of the housing 50, and FIG. 4(b) is a sectional view thereof. A shape of the heat transfer body 20 is not particularly limited. For example, as depicted in FIG. 4(a), the heat transfer body 20 may have a shape bent along the cylindrical power storage body 10.

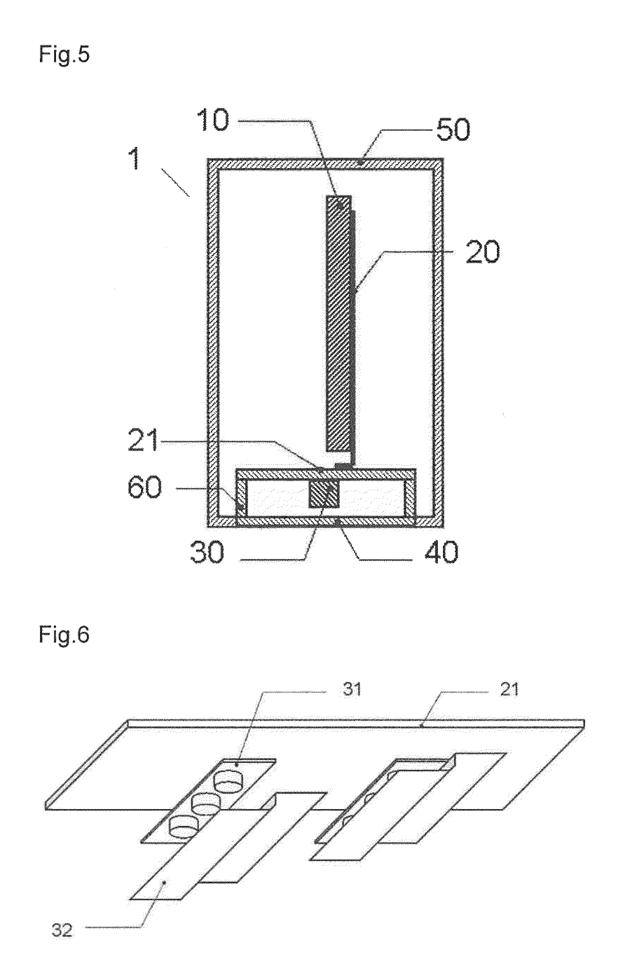

The heat transfer body 20 may be made of any material as long as the material can transfer heat. For example, metal foil or the like may be used. The heat transfer body 20 and the heat-sensitive deformable body 30 may be provided so that the heat transfer body 20 physically directly contacts with the heat-sensitive deformable body 30, as described in FIGS. 1 to 4. In addition, as described in FIG. 5, a fixed portion 21 as a part of the heat transfer body 20 is fixed so as to be separated from the heat radiating body 40 by a predetermined distance through a spacer 60 that hardly transfers heat. On the fixed portion 21 may be provided the heat-sensitive deformable body 30.

The heat-sensitive deformable body 30 may be made of any material deforming as temperature thereof rises. For example, bimetal having heat conductivity may be used, or a combination of air bubble-containing film and heat transfer foil may be used. A piezoelectric element (piezo actuator) may alternatively be used. The following describes an example using air bubble film as the heat-sensitive deformable body 30.

FIG. 6 is a perspective view of an example in which air bubble-containing film is used as the heat-sensitive deforming unit in the power storage device according to the first embodiment of the present invention. In the drawing, the power storage unit 10, the heat radiating body 40, and the housing 50 are omitted. Air bubble film 31 is composed of two pieces of polyethylene sheet, one of which is molded into cylindrical projections. The fixed portion 21, which is a part of the heat transfer body 20, is fixed so as to be separated from the heat radiating body 40 by a predetermined distance. Heat transfer foil 32 may be copper foil having a thickness of from 20 to 70 μm, contacts with the fixed portion 21, and is fixed on an upper surface of the cylindrical projections of the air bubble film 31.

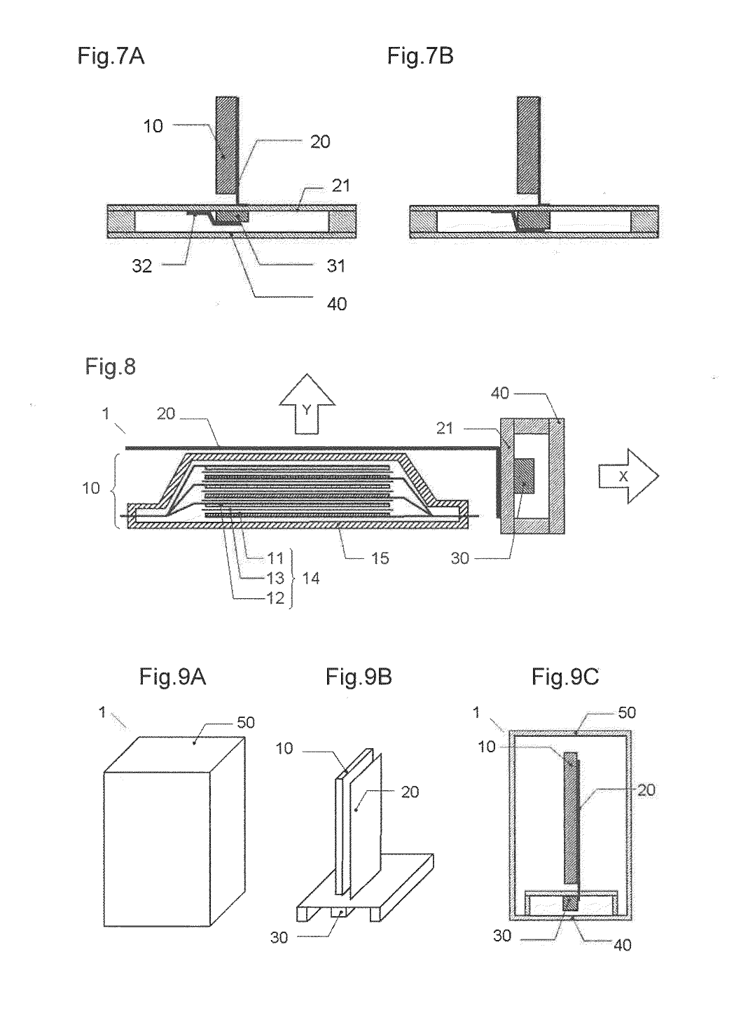

FIG. 7 includes sectional views of the power storage device 1 in which the air bubble film 31 is used as the heat-sensitive deformable body in the power storage device according to the first embodiment of the present invention. FIG. 7(a) depicts a state in which the heat transfer foil 32 is not in contact with the heat radiating body 40, and FIG. 7(b) depicts a state in which the air bubble film 31 expands and thereby the heat transfer foil 32 is in contact with the heat radiating body 40. The housing 50 is omitted in the drawing.

A distance from the fixed portion 21 to the heat radiating body 40 is set depending on a temperature (a predetermined temperature) at which heat radiation of the power storage body 10 is desired. In other words, the distance from the fixed portion 21 to the heat radiating body 40 may be determined based on a height of the cylindrical projection of the air bubble film 31 at the predetermined temperature. Herein, it can also be considered that heat transferability between the heat transfer foil 32 and the heat radiating body 40 does not necessarily discontinuously change beyond the predetermined temperature. In other words, since strength of contact between the heat transfer foil 32 and the heat radiating body 40 continuously changes due to pressure change in the air bubble film 31, heat transferability can also be considered to continuously change.

For example, in order to thermally contact the heat transfer foil 32 with the heat radiating body 40 when the temperature of the power storage body 10 is 60° C. or more and to thermally separate when the temperature thereof is −15° C. or less, the distance from the fixed portion 21 to the heat radiating body 40 is determined as follows. That is, the height of the cylindrical projection of the air bubble film 31 at 22.5° C. as an intermediary temperature can be determined as the distance from the fixed portion 21 to the heat radiating body 40. When the distance from the fixed portion 21 to the heat radiating body 40 is determined as above, almost no pressure is applied to a contact surface of the heat transfer foil 32 and the heat radiating body 40 at 22.5° C., and heat transferability on the contact surface is also low. Thus, heat radiation effect on the power storage body 10 is small. When the temperature rises to 22.5° C. or more, pressure to the contact surface increases and heat transferability on the contact surface also increases, whereby the heat radiation effect on the power storage body 10 is enhanced. Pressure change on the contact surface due to the temperature rise can be roughly estimated from the equation of state of ideal gas. The equation of state of ideal gas is as follows:

PV=nRT (in which P represents pressure, V represents volume, n represents the number of moles of gas, R represents gas constant, and T represents gas temperature (Kelvin)). From the equation of ideal gas, assuming that a volume of the air bubble film 31 does not change, pressure of (273+60)/(273+22.5)≈1.13 times is applied to the contact surface at 60° C., thereby enhancing the heat radiation effect on the power storage body 10. On the other hand, pressure applied to the contact surface at −15° C. is (273−15)/(273+22.5)≈0.87 times, thus the conductive foil 32 is thermally separated from the heat radiating body 40.

In addition, for example, in order to thermally contact the heat transfer foil 32 with the heat radiating body 40 when the temperature of the power storage body 10 is 30° C. or more and separate when the temperature thereof is 0° C. or less, the distance from the fixed portion 21 to the heat radiating body 40 may be a height of the cylindrical projection of the air bubble film 31 at 15° C.

Setting of the distance from the fixed portion 21 to the heat radiating body 40 described above presupposes that the volume of the cylindrical projection of the air bubble film 31 changes only in a projection direction. Since lateral contraction or the like depends on a shape and material of the air bubble film 31, the distance from the fixed portion 21 to the heat radiating body 40 is set by correcting as needed.

The heat-sensitive deformable body 30 may be provided on any place as long as contacting with the heat transfer body 20. Preferably, the heat-sensitive deformable body 30 may be provided in a surface direction of electrodes included in the power storage body 10.

FIG. 8 depicts a position for arranging the heat-sensitive deformable body in the power storage device according to the first embodiment of the present invention. The power storage body 10 of the power storage device 1 depicted in FIG. 8 is a lithium ion secondary battery including power storage elements 14 each formed by alternately laminating a positive electrode 11 and a negative electrode 12 through a separator 13, and laminate film 15 sealing the power storage elements 14. The housing 50 is omitted in the drawing.

Expansion of the power storage body 10 occurs in a thickness direction with respect to the electrodes (the positive electrodes 11 and the negative electrodes 12). This results from expansion of active material on the electrodes. Expansion in a surface direction with respect to the electrodes is suppressed due to adhesiveness by binder between the active material forming the electrodes and electric collectors. On the other hand, expansion in a thickness direction with respect to the electrodes is suppressed by physical restriction in a thickness direction of the laminate film 15 covering the electrodes, however, the suppression is weak due to flexibility of the laminate film 15. Accordingly, the expansion of the power storage body 10 occurs mainly in the thickness direction with respect to the electrodes.

Arrows X and Y in FIG. 8 represent positional relationship with respect to the electrodes, in which the arrow X represents a surface direction with respect to the electrodes and the arrow Y represents a thickness direction with respect thereto. The heat-sensitive deformable body 30 may be arranged in either the surface direction X or the thickness direction Y with respect to the electrodes but preferably may be provided in the surface direction X.

As described above, the power storage body 10 expands in the thickness direction Y with respect to the electrodes. For example, when using the housing 50 covering the power storage device 1 as the heat radiating body 40, arrangement of the heat-sensitive deformable body in the thickness direction Y may cause the heat-sensitive deformable body 30 to be pushed against the heat radiating body 40, as in the battery pack described in Patent Literature 1. Arrangement of the heat-sensitive deformable body 30 in the surface direction X allows a distance from the heat-sensitive deformable body 30 to the heat radiating body 40 to be more securely maintained regardless of the expansion of the power storage body 10 in the thickness direction Y, thus connection and separation between the power storage body and the heat radiating body can be appropriately performed.

Even in the cylindrical power storage body formed by interposing the positive and negative electrodes between separators and winding the electrodes into a swirl shape, it is preferable to arrange the heat-sensitive deformable body 30 in the surface direction with respect to the electrodes, because even when the power storage body expands, connection and separation between the power storage body and the heat radiating body can be appropriately performed.

The heat radiating body 40 may be made of metal having high heat radiation property, such as iron or aluminum. The heat radiating body 40 is fixed so as to be separated from the heat-sensitive deformable body by a predetermined distance. For example, as depicted in FIG. 5, there may be provided a structure in which the fixed portion 21 is provided through the spacer 60 and the heat-sensitive deformable body 30 is arranged on the fixed portion 21. Providing the spacer 60 can ensure that the heat radiating body 40 is fixed so as to be separated from the heat-sensitive deformable body 30 by a predetermined distance.

The housing 50 is provided so as to cover the power storage body 10, the heat transfer body 20, and the heat-sensitive deformable body 30. The housing 50 thermally insulates the power storage body 10, the heat transfer body 20, and the heat-sensitive deformable body 30 from the outside air or the like contacting with the heat radiating body 40. In addition, additionally covering the power storage body 10, the heat transfer body 20, and the heat-sensitive deformable body 30 with resin having high thermal resistance may ensure thermally insulating from the outside air or the like.

The heat radiating body 40 may be a part of the housing 50. FIG. 9(a) is a perspective view of an example in which the heat radiating body 40 is a part of the housing 50 in the power storage device according to the first embodiment of the present invention. FIG. 9(b) is a perspective view depicting the power storage body 10, the heat transfer body 20, and the heat-sensitive deformable body 30 included in the housing 50. FIG. 9(c) is a sectional view of FIG. 9(a).

As depicted in FIG. 9(a), in a power storage device 1 according to a first embodiment of the present invention, the housing 50 covers the power storage body 10, the heat transfer body 20, and the heat-sensitive deformable body 30. Inside the housing 50 are arranged the power storage body 10, the heat transfer body 20, and the heat-sensitive deformable body 30 depicted in FIG. 9(b). Furthermore, as depicted in FIG. 9(c), the heat radiating body 40 is a part of the housing 50.

The power storage body 10, the heat transfer body 20, and the heat-sensitive deformable body 30 are thermally insulated from the outside air or the like contacting with the heat radiating body 40 by the housing 50. The power storage body 10, the heat transfer body 20, and the heat-sensitive deformable body 30 may be in contact with the housing 50 when thermally insulated from the outside air or the like. When the power storage body 10, the heat transfer body 20, and the heat-sensitive deformable body 30 are not thermally insulated from the outside air or the like, arranging the power storage body 10, the heat transfer body 20, and the heat-sensitive deformable body 30 so as to be apart from the housing 50 allows for thermal insulation between the storage battery 10 and the outside air or the like.

Having the structure as described above can reduce the number of components, since the heat radiating body 40 is a part of the housing 50.

### Second Embodiment

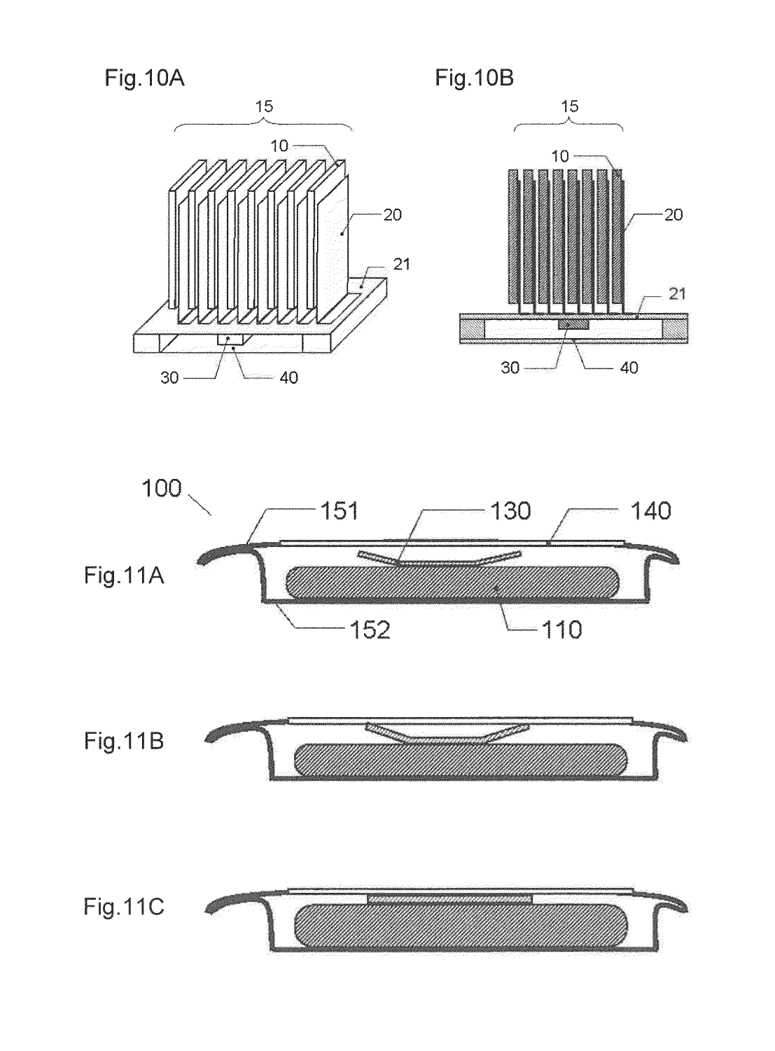

A description will be given of a power storage device 1 according to a second embodiment of the present invention with reference to FIG. 10. The second embodiment is the same as the first embodiment except that a plurality of power storage bodies 10 are provided and heat transfer bodies 20 are provided corresponding to the respective power storage bodies 10. Numbers described in FIG. 10 represent the same structure as those depicted in FIGS. 1 to 9. The housing 50 is omitted in the drawings.

FIG. 10(a) is a perspective view of the power storage device 1 according to the second embodiment of the present invention, and FIG. 10(b) is a sectional view thereof. The power storage device according to the second embodiment of the present invention forms an assembled battery 15 provided with a plurality of power storage bodies 10, as depicted in FIG. 10. Heat transfer bodies 20 are provided corresponding to the plurality of respective power storage bodies 10.

When an assembled battery is formed by using a plurality of power storage bodies as module units, each of the power storage bodies generates heat during charging and discharging and is affected by heat generation of power storage bodies positioned on both sides of the power storage body. One side of a power storage body positioned at the end that is not in contact with any other power storage body is not affected, whereas a power storage body positioned at the middle is affected by heat generation of power storage bodies on both sides thereof. As a result, the middle of the assembled battery has a higher temperature than the end thereof. When a temperature of the assembled battery becomes uneven, deterioration progress becomes different and unbalanced between the respective power storage bodies. Continuing operation of the assembled battery in the unbalanced state causes performance of the entire assembled battery to be controlled by more deteriorated power storage bodies. Thus, even though there are still some non-deteriorated power storage bodies, the assembled battery does not work anymore.

According to the power storage device of the second embodiment of the present invention, even when the power storage body 10 expands, a distance between the heat-sensitive deformable body 30 and the heat radiating body 40 does not change, and at the same time a plurality of power storage bodies 10 are mutually connected, thereby a temperature of the assembled battery 15 can be equalized.

The power storage device and the method for radiating heat from a power storage body according to the present invention have been described based on the above embodiments but are not limited thereto. It is obvious that various modifications, changes, and improvements can be included for the embodiments within the scope of the present invention based on the basic technical concept of the invention.

In addition, diverse combinations, substitutions, and selections of various disclosed elements can be made within the scope of the claims of the present invention. Further problems, objects, and extended embodiments of the invention will be apparent also from the entire disclosed matter of the invention including the claims.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese Patent Application No. 2012-079417, filed on Mar. 30, 2012, the disclosure of which is incorporated herein in its entirety by reference.

### REFERENCE SIGNS LIST

1 Power storage device
10 Power storage body
11 Positive electrode
12 Negative electrode
13 Separator
14 Power storage element
15 Assembled battery
20 Heat transfer body
21 Fixed portion
30 Heat-sensitive deformable body
31 Air bubble film
32 Heat transfer foil
40 Heat radiating body
50 Housing
60 Spacer
100 Battery pack
110 Secondary battery
130 Heat-sensitive deformable body
140 Metal heat radiating body
151 Pack outer package case
152 Pack outer package cover

1. A power storage device comprising:
a power storage body;
a heat transfer body thermally contacted with the power storage body;
a heat radiating body thermally separated from both the power storage body and the heat transfer body;
a heat-sensitive deformable body arranged so as to contact with the heat radiating body at a predetermined temperature due to positive thermal expansion and to separate from the heat radiating body at a temperature less than the predetermined temperature, and thermally contacted with the heat transfer body; and
a heat insulating body thermally insulating the power storage body, the heat transfer body, and the heat-sensitive deformable body from surroundings.

2. The power storage device according to claim 1, wherein the heat radiating body and the heat-sensitive deformable body are fixed so as to be separated from each other by a predetermined distance through a spacer provided between the heat radiating body and the heat-sensitive deformable body.

3. The power storage device according to claim 1, wherein the power storage body includes at least an electrode, and the heat-sensitive deformable body is provided in a surface direction of the electrode.

4. The power storage device according to claim 1, wherein a part of the heat transfer body is a fixed portion fixed so as to be separated from the heat radiating body by a predetermined distance, and the heat-sensitive deformable body is provided on the fixed portion.

5. The power storage device according to claim 1, wherein the power storage body includes a plurality of power storage bodies, and the heat transfer body is provided corresponding to each of the power storage bodies.

6. The power storage device according to claim 1, wherein the heat-sensitive deformable body is air bubble-containing film.

7. The power storage device according to claim 1, wherein the power storage body is a lithium ion secondary battery in which a power storage element is sealed with laminate.

8. The power storage device according to claim 1, wherein the heat insulating body is a housing, and the heat radiating body is a part of the housing

9. The power storage device according to claim 8, wherein the power storage body, the heat transfer body, and the heat-sensitive deformable body are apart from the housing.

10. A method for radiating heat in a power storage device, comprising:
including a power storage body; a heat transfer body thermally contacted with the power storage body; a heat radiating body thermally separated from both the power storage body and the heat transfer body; a heat-sensitive deformable body thermally contacted with the heat transfer body; and a heat insulating body thermally insulating the power storage body, the heat transfer body, and the heat-sensitive deformable body from surroundings,
contacting the heat-sensitive deformable body with the heat radiating body at a predetermined temperature due to positive thermal expansion; and
separating the heat-sensitive deformable body from the heat radiating body at a temperature less than the predetermined temperature.
